(19) United States
(12) Patent Application Publication
(10) Pub. No.: US 2009/0191883 A1
(43) Pub. Date: Jul. 30, 2009

(54) METHOD AND DEVICE FOR TRANSMITTING DATA

(75) Inventors: Hyung-Nam Choi, Hamburg (DE); Maik Bienas, Braunschweig (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 12/019,831

(22) Filed: Jan. 25, 2008

(51) Int. Cl. H04Q 7/20

(52) U.S. Cl. 455/450

(57) ABSTRACT

A method for transmitting data including determining at least one allowable time period which is allowed to be used for data transmission via a communication channel during a time interval which is pre-defined as a transmission gap for the communication channel for carrying out measurements in a first frequency range which is different from a second frequency range used for data transmissions via the communication channel; and transmitting data during the at least one allowable time period via the communication channel.

### TECHNICAL FIELD

Embodiments relate generally to a method for transmitting data, a communication device, a method for controlling a data transmission, and a network circuit.

### BACKGROUND

With the increasing use of wireless communication systems data transmission methods which make efficient use of communication resources are desirable. In addition, with regard to quality of service requirements of communication channels, methods for data transmission allowing high throughput and low transmission delay are desirable.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a mobile radio communication system according to one embodiment;

FIG. 2 shows a flow diagram according to an embodiment;

FIG. 3 shows a flow diagram according to an embodiment;

FIG. 4 shows DTX patterns according to an embodiment;

FIG. 5 shows a flow diagram according to an embodiment;

FIG. 6 shows a communication device according to an embodiment;

FIG. 7 shows a flow diagram according to an embodiment; and

FIG. 8 shows a flow diagram according to an embodiment.

### DESCRIPTION

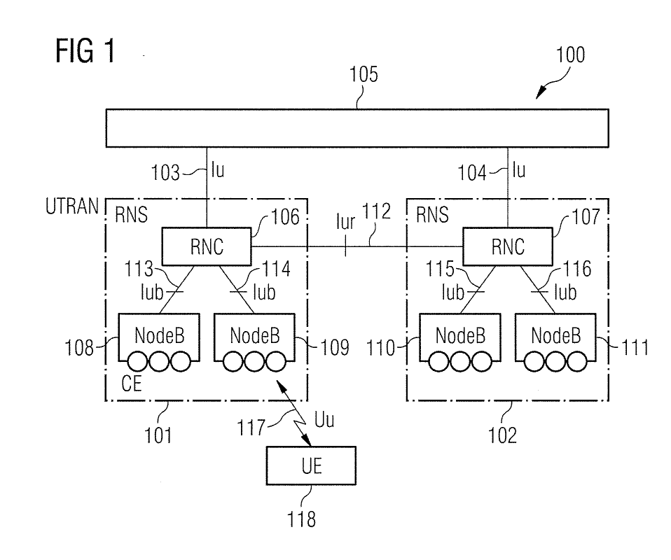

FIG. 1 shows a mobile radio communication system 100 according to one embodiment.

In this embodiment, the mobile radio communication system 100 is a UMTS mobile radio communication system 100 and includes a UMTS mobile radio access network (UMTS Terrestrial Radio Access Network, UTRAN), which has a plurality of mobile radio network subsystems (RNS) 101, 102, which are respectively connected to the UMTS core network (CN) 105 by means of what is known as an Iu interface 103, 104. A mobile radio network subsystem 101, 102 respectively has a mobile radio network control unit (Radio Network Controller, RNC) 106, 107 and one or more UMTS base stations 108, 109, 110, 111, which are also called NodeB in line with UMTS.

Within the mobile radio access network, the mobile radio network control units 106, 107 of the individual mobile radio network subsystems 101, 102 are connected to one another by means of what is known as an Iur interface 112. Each mobile radio network control unit 106, 107 respectively monitors the allocation of mobile radio resources in all mobile radio cells in a mobile radio network subsystem 101, 102.

A UMTS base station 108, 109, 110, 111 is respectively connected to a mobile radio network control unit 106, 107 associated with the UMTS base station 108, 109, 110, 111 by means of what is known as an Iub interface 113, 114, 115, 116.

Each UMTS base station 108, 109, 110, 111 provides radio coverage for one or more mobile radio cells (CE) within a mobile radio network subsystem 101, 102. Message signals or data signals are transmitted between a respective UMTS base station 108, 109, 110, 111 and a subscriber station 118 (User Equipment, UE), subsequently also called a mobile radio terminal, in a mobile radio cell using an air interface, called a Uu air interface 117 in line with UMTS, e.g. on the basis of a multiple access transmission method.

It should be noted that FIG. 1 shows just one mobile radio terminal 118 for reasons of simple illustration. In general, however, any number of mobile radio terminals 118 are provided in the mobile radio communication system 100.

The communication between a mobile radio terminal 118 and another communication station can be set up using a complete mobile radio communication link to another mobile radio terminal, alternatively to a landline communication station.

For the further development of UMTS mobile communication systems according to release 8 a work item has been created in Third Generation Partnership Project (3GPP) standardization fora with the goal of an enhancement of the performance of the RACH (random access channel) transport channel which is according to release 8 referred to as eRACH (enhanced random access channel). It is based on W-CDMA (wideband code division multiple access) and to be used in UMTS FDD (frequency division duplexing) mode. According to the work item, the RACH should be enhanced with regard to capacity, throughput, and transmission delay. To achieve these goals, the following features are considered: transmission time intervals (TTIs) of length 2 ms and 10 ms, closed-loop power control, NodeB scheduling and HARQ (hybrid automatic repeat request).

According to UMTS, when a mobile radio terminal 118, also referred to as UE (user equipment) according to UMTS, is in the state CELL_FACH it performs interfrequency measurement and inter-RAT (radio access technology) measurements during so-called measurement gaps. These measurement gaps for example have a length of 10, 20, 40 or 80 ms and occur periodically. During a measurement gap, there is no uplink data transmission and/or downlink data transmission depending on the type of measurement to be carried out in the measurement gap. Uplink data transmission refers to the transmitting of data from the mobile radio terminal 118 to a base station 108, 109, 110, 111 and downlink data transmission refers to the transmission of data from a base station 108, 109, 110, 111 to the mobile radio terminal 118.

With regard to the eRACH measurement gaps may have impact on the eRACH performance since it may occur that a TTI of the eRACH is not allowed to be used for uplink data transmission when it overlaps with a measurement gap.

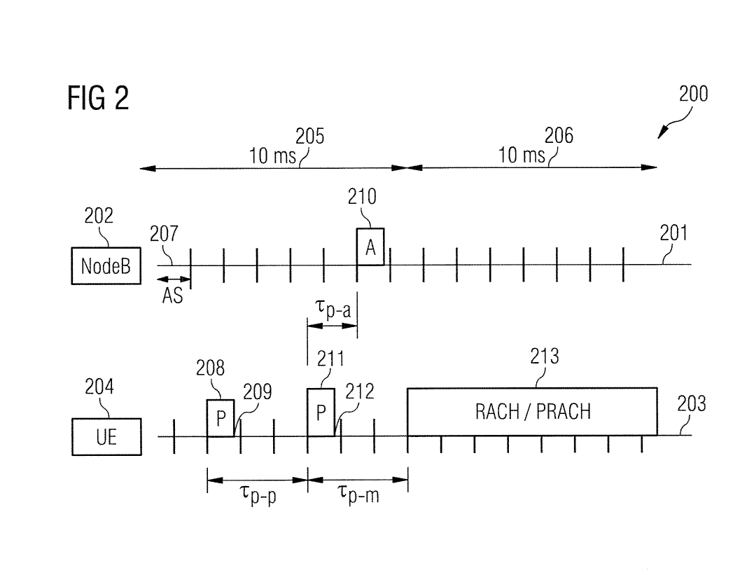

In UMTS FDD mode according to release 7 and based on W-CDMA a random access procedure may be used for discontinuous transmission of data in uplink using the RACH. This random access procedure is illustrated in FIG. 2.

FIG. 2 shows a flow diagram 200 according to an embodiment.

In FIG. 2, the flow of time is illustrated from left to right. In a first subdiagram 201, events at a base station 202 for example corresponding to a base station 108, 109, 110, 111 of the mobile radio communication system 100 illustrated in FIG. 1 are illustrated. In a second subdiagram 203 events occurring at a mobile radio terminal 204 (e.g. corresponding to the mobile terminal 118) are illustrated.

The physical random access channel (PRACH) carries the RACH transport channel, in other words, the RACH transport channel is mapped to the PRACH in the physical layer. The TTI of the RACH is for example 10 ms or 20 ms. In this example, the first TTI 205 and a second TTI 206, in this example of length 10 ms, are shown. It should be noted that all values given in this specification, for example the length of TTIs or other time intervals, are only examples and may be different in other embodiments.

In a radio cell up to 16 RACH/PRACH pairs may be configured in one embodiment. The configuration is broadcast to all mobile radio terminals in the radio cell. The RACH/PRACH pairs are common resources, in other words they are shared and may be used by all mobile radio terminals in the radio cell.

When a mobile radio terminal 118 wants to transmit data in uplink on a RACH it uses random access transmission, i.e. a random access procedure, which is based on a slotted ALOHA approach with fast acquisition indication. The mobile radio terminal 118 starts the random access transmission at the beginning of a so-called access slot (AS) 207. There are 15 access slots per two TTIs and they occur every 5120 chips. The mobile radio terminal 204 starts the random access transmission with a PRACH preamble acquisition procedure by transmitting a preamble 208 of length 4096 chips with a predetermined transmission at a randomly selected access slot, in this example in a first access slot 209.

If the base station 202 detects the transmission of the preamble 208 it transmits a positive acknowledgement 210 on the acquisition indicator channel (AICH) within the time τₚ₋ₐ after the beginning of the transmission of the preamble 208. In this example, it is assumed that the base station 202 has not detected the preamble 208 sent in the first access slot 209. In this case, the base station 202 does not transmit the acknowledgement 210 and the mobile radio terminal transmits, after a randomly selected time τₚ₋ₚ a new preamble 211 in a randomly selected second access slot 212 to the base station. The new preamble 211 is transmitted with increased transmission power with respect to the preamble 208.

When the base station 202 detects the transmission of a preamble, as it is assumed in case of the new preamble 211 in this example, the base station 202 transmits the acknowledgement 210 on the AICH. After the time τp-m after the beginning of the second access slot 212, the mobile radio terminal, having received the acknowledgement 210, transmits data on the RACH/PRACH as indicated by block 213 in FIG. 2. After the data has been transmitted by the mobile radio terminal 204 the random access procedure ends and for a subsequent transmission of uplink data the mobile radio terminal 204 initiates the random access procedure again.

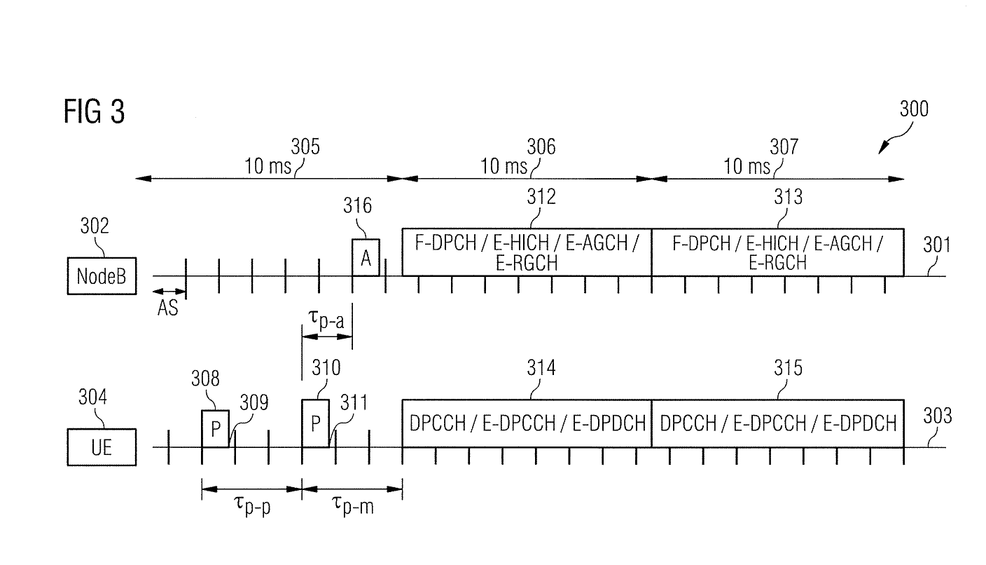

In FIG. 3, the enhanced RACH procedure, i.e. the random access procedure for the eRACH is illustrated.

FIG. 3 shows a flow diagram 300 according to an embodiment.

Analogously to FIG. 2, in a first subdiagram 301, the events occurring at a base station 302 are shown and in a second subdiagram 303 the events occurring at a mobile radio terminal 304 are shown. The events occurring in the first TTI 305, in a second TTI 306, and a third TTI 307, in this example each of length 10 ms, are illustrated. As in the random access procedure described with reference to FIG. 2, the mobile radio terminal 304 starts the random access procedure by transmitting a preamble 308 at the beginning of a randomly selected first access slot 309 and, if there is no acknowledgement by the base station 302 on the AICH, transmits a new preamble 310 in a randomly selected second access slot 311. When the base station 302 detects a preamble transmitted by the mobile radio terminal 304, in this example the new preamble 310, it assigns eRACH resources to the mobile radio terminal 304.

The eRACH resources that may be assigned are the physical channels DPCCH (dedicated physical control channel), E-DPCCH (E-DCH DPCCH), and E-DPDCH (E-DCH dedicated physical data channel) for uplink data transmission and F-DPCH (fractional dedicated physical channel), E-HICH (E-DCH HARQ Acknowledgement Indicator Channel), E-RGCH (E-DCH relative grant channel), and E-AGCH (E-DCH absolute grant channel) for downlink data transmission. Once the eRACH is established, closed-loop power control is applied over DPCCH and F-DPCH, scheduling grants are sent by the base station 302 via the E-AGCH and E-RGCH, and ACK/NACK (acknowledgement/negative acknowledgement) feedback as response to uplink transmission on E-DPDCH is sent using the E-HICH. The uplink or downlink data transmission carried out after eRACH resources have been assigned to the mobile radio terminal 304 is indicated by blocks 312, 313, 314 and 315 in FIG. 3. Blocks 312 and 313 illustrate downlink data transmission by the base station 302 and blocks 314 and 315 illustrate uplink data transmission by the mobile radio terminal 304.

Analogously to the random access procedure described with reference to FIG. 2, the data transmission may start after the time τₚ₋ₘ after the beginning of the transmission of the new preamble 310 that has been received and acknowledged by an acknowledgement 316 by the base station 302.

Measurement gaps are configured for the mobile radio terminal 118 having only a single transceiver to allow the mobile radio terminal 118 to carry out inter frequency measurements, e.g. measurements of radio cells using other frequencies than the one in which the mobile radio terminal 118 is currently registered, and inter-RAT measurements, i.e. measurements of radio cells belonging to other mobile radio communication systems than the one currently used by the mobile radio terminal 118, e.g. radio cells of a GSM (global system for mobile communications) mobile radio communication system. During a measurement gap, no data transmission in uplink and/or in downlink is allowed, depending on the type of measurement to be carried out during the measurement gap.

When the mobile radio terminal 118 is in CELL_FACH state it carries out interfrequency measurements and inter-RAT measurements according to the “FACH measurement occasions” specification, i.e. in radio frames that have an SFN (system frame number) value fulfilling

SFN div N=C_{—}RNTI mod M_{—}REP+n*M_{—}REP, or Formula 1

SFN=H-RNTI mod M_{—}REP+n*M_{—}REP, Formula 2

wherein:
SFN: System Frame Number of the radio frame (e.g. of length 10 ms)
C-RNTI, H-RNTI: UE identity
N: TTI of FACH transport channel having the largest TTI on the SCCPCH monitored by the UE
M_REP: FACH measurement occasion cycle length in radio frames n=0, . . . , 4095.

According to formula 1, the measurement gaps may have a length of 10 ms, 20 ms, 40 ms, or 80 ms and occur periodically with a rate of N*M_REP. According to formula 2, the measurement gaps may have a length of 10 ms and occur periodically with rate M_REP. The mobile radio terminal carries out its measurements during the measurement gaps given by the SFNs according to the formulas.

For UMTS FDD mode according to release 7 the concept of UL DTX (uplink discontinuous transmission) for dedicated channels is specified. The goal of the usage of UL DTX is to reduce the interference in uplink data transmission due to physical control channels used by packet data users that are temporarily not transmitting data. By reducing this type of interference the number of packet data users that may stay in CELL_DCH state over a long time period may be increased without degrading the throughput in the radio cell. This allows a high number of users to restart data transmission after a period of inactivity with a much shorter delay than the delay that would occur in case of a reestablishment of a communication connection.

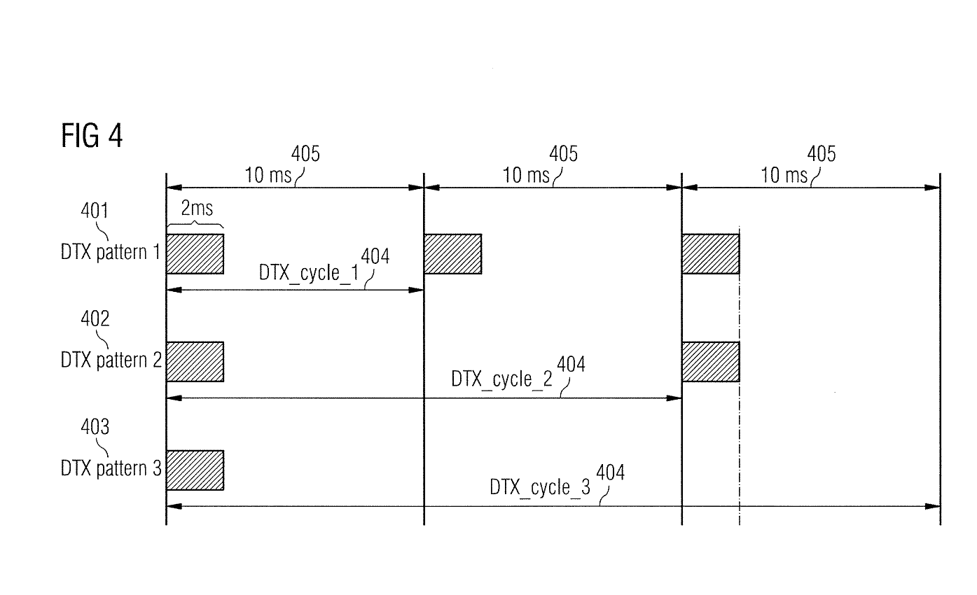

Examples for DTX patterns are shown in FIG. 4.

FIG. 4 shows a first DTX pattern 401, a second DTX pattern 402, and a third DTX pattern 403 according to one embodiment.

Each DTX pattern 401, 402, 403 may be defined by its DTX cycle length 404 which gives the time between two successive data transmission periods according to the respective DTX pattern 401, 402, 403 and the allowed transmission time which gives the maximum length of a data transmission per DTX cycle.

According to the first DTX pattern 401, the allowed transmission time is 2 ms and the DTX cycle length is 10 ms. According to the second DTX pattern 402 the allowed transmission time is 2 ms and the DTX cycle length is 20 ms. According to the third DTX pattern the allowed transmission time is 2 ms and the DTX cycle length is 30 ms. It is to be emphasized that the times used in these embodiments are only exemplary and described for illustrative purposes. Other time specifications may be provided in alternative examples. In this example, the DTX patterns 401, 402, 403 are defined with respect to the radio frames 405 of length 10 ms each being identified by its SFN (system frame number). The beginning time instants of the radio frames 405 may be defined by the downlink transmission timing and are known by the base station and the mobile radio terminal. In this example, the transmission periods of the DTX cycles start at the beginning of a radio frame. By way of example, the transmission periods according to the second DTX pattern 402 start at the beginning of every second radio frame 405. However, there may be an offset between the beginning of a radio frame 405 and the beginning of a transmission period. For example, in one emodiment the transmission period of length 2 ms may start 3 ms after the beginning of every second radio frame 405.

In one embodiment, time periods which are allowed for data transmission, for example defined in accordance with a DTX pattern, are used for data transmission during measurement gaps. This is illustrated in FIG. 5.

FIG. 5 shows a flow diagram 500 according to an embodiment.

The flow illustrates a method for transmitting data. In 501, at least one allowable time period is determined which is allowed to be used for data transmission via a communication channel during a time interval which is pre-defined as a transmission gap for the communication channel for carrying out the measurements in a first frequency range which is different from a second frequency range used for data transmissions via the communication channel.

In 502, data is transmitted during the at least one allowable time period via the communication channel.

In one embodiment, the time interval which may be defined as a measurement gap for a communication channel, i.e. which is defined as a time interval in which uplink and/or downlink data transmissions are forbidden using the communication channel since measurements are to be carried out in which signals are measured that have frequencies that are different from the frequency range used for data transmission using the communication channel, is used for data transmission in spite of its definition as measurement gap by defining certain time periods during which data transmission is allowed. One or more allowable time periods during the time interval are used for data transmission and, for example, one or more measurements to be carried out during the measurement gap are carried out during the rest of the measurement gap, i.e. during a time period in the measurement gap that is not used for data transmission.

In one embodiment, the measurements are carried out during the time interval determined in 501. For example, the measurements are carried out during other time periods of the time interval than the at least one allowable time period.

In one embodiment, the method illustrated in FIG. 5 may further include receiving a specification of the at least one allowable time period. The specification is for example received from a network component of the communication network.

For example, the determining of the at least one allowable time period includes determining a pre-defined pattern of allowable time periods. The determining of the at least one allowable time period may for example include determining a plurality of allowable time periods and selecting the at least one allowable time period from the plurality of allowable time periods based on a pre-determined criterion. The selection is for example based on the length of the measurement gap and/or based on the number of measurements to be performed.

In one embodiment, the method illustrated in FIG. 5 further includes signalling to a network component of a communication network a specification of the at least one determined allowable time period.

The method illustrated in FIG. 5 is for example carried out by a mobile communication terminal of a mobile communication system. The measurement is for example a measurement of the reception quality of a signal sent by a base station of the mobile communication system. For instance, the measurement is a measurement of the reception field strength of a signal sent by the base station in a radio cell.

In one embodiment, the data transmission is an uplink data transmission from the mobile communication terminal to a base station of the mobile communication system.

The mobile communication system is for example a mobile communication system according to UMTS. It may also be a communication system according to another mobile communication standard such as FOMA (freedom of mobile access), GSM (global system for mobile communications), or CDMA2000 (CDMA: code division multiple access).

In case of an UMTS mobile communication system the allowable time period is for example a time period allowed for data transmission via the communication channel when the mobile communication terminal is in CELL_FACH state.

The communication channel is for example a shared communication channel. In one embodiment, the communication channel is a random access channel, for example an eRACH. The communication channel may also be another communication channel in other embodiments, for example another shared communication channel for uplink and/or downlink data transmission or a dedicated communication channel for uplink and/or downlink data transmission.

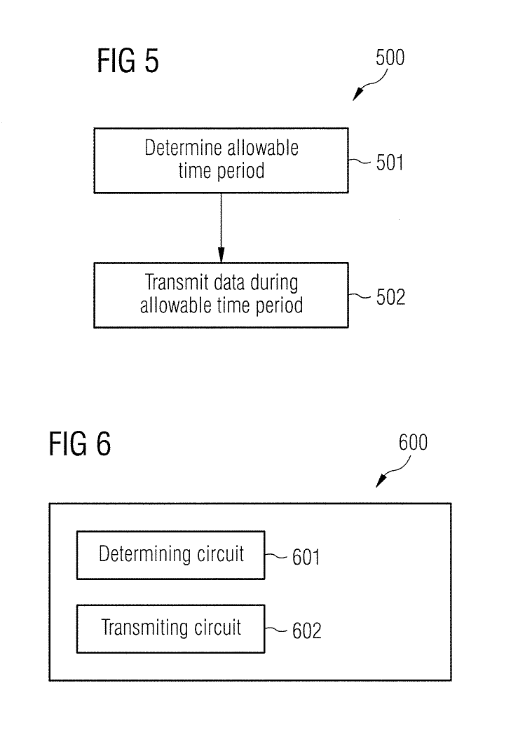

The method illustrated in FIG. 5 is for example carried out by a communication device as shown in FIG. 6.

FIG. 6 shows a communication device 600 according to an embodiment.

The communication device 600 includes a determining circuit 601 configured to determine at least one allowable time period which is allowed to be used for data transmission via a communication channel during a time interval which is pre-defined as a transmission gap for the communication channel for carrying out measurements in a first frequency range which is different from a second frequency range used for data transmissions via the communication channel.

The communication device 600 further includes a transmitting circuit 602 configured to transmit data during the at least one allowable time period via the communication channel.

The communication device 600 is for example a wireless communication device, for example a mobile communication device (mobile terminal) of a mobile communication system.

In one embodiment, a method for controlling a data transmission is carried out including generating a message including a specification of at least one allowable time period which is allowed to be used for data transmission via a communication channel during a time interval which is pre-defined as a transmission gap for the communication channel for carrying out measurements by a communication terminal in a first frequency range which is different from a second frequency range used for data transmissions via the communication channel; and transmitting the message to the communication terminal. For example, the communication terminal is the communication device 600 described with reference to FIG. 6.

The method for controlling a data transmission is for example carried out by a network circuit of a communication system including a message generating circuit configured to generate a message including a specification of at least one allowable time period which is allowed to be used for data transmission via a communication channel during a time interval which is pre-defined as a transmission gap for the communication channel for carrying out measurements by a communication terminal in a first frequency range which is different from a second frequency range used for data transmissions via the communication channel; and a transmitter configured to transmit the message to the communication terminal.

For example, the network circuit is a base station (or part of a base station) of a mobile communication system.

A memory used in the embodiments of the invention may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be software being implemented or executed by a processor, e.g. any kind of computer program, e.g. a computer program using a virtual machine code such as e.g. Java. Any other kind of implementation of the respective functions which will be described in more detail below may also be understood as a “circuit” in accordance with an alternative embodiment.

In the following, examples for embodiments are described where a UMTS mobile communication system as shown in FIG. 1 is used. It is assumed that UMTS FDD mode according to release 8 based on W-CDMA is used and that the mobile radio terminal 118 is located and using a radio cell that supports the enhanced RACH procedure described with reference to FIG. 3. It is further assumed that the mobile radio terminal 118 is in the RRC (radio resource control) state CELL_FACH and uses the eRACH for uplink data transmission with a TTI of 10 ms. The mobile terminal 118 is further assumed to be configured by the UTRAN with a set of interfrequency measurements and inter-RAT measurements.

The mobile communication system 100 allows discontinuous transmission during measurement gaps. To do this, the UTRAN (e.g. the base station operating the radio cell in which the mobile terminal 118 is located or another network component of the mobile communication system 100) signals a list of allowed DTX patterns to the mobile terminal 118 which, in this example, are the DTX patterns 401, 402, 403 illustrated in FIG. 4.

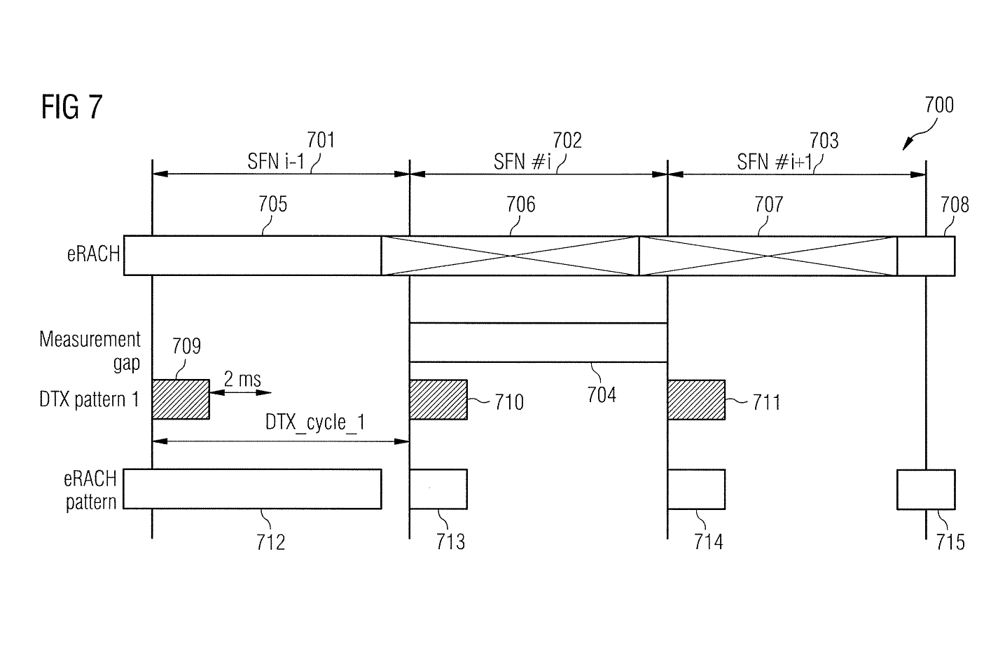

One example of a data transmission during a measurement gap by the mobile terminal 118 is described in the following with reference to FIG. 7.

FIG. 7 shows a flow diagram 700 according to an embodiment. In the flow diagram 700 the events occurring in a first radio frame (system frame number i-1) 701, in a second radio frame (system frame number i) 702, and a third radio frame (system frame number i+1) 703 are illustrated. A measurement gap 704 is configured for the mobile terminal 118. In this example, the measurement gap 704 has a length of 10 ms and covers the period of the second radio frame 702. The measurement gap 704 is for example scheduled such that it periodically occurs every 200 ms. The measurement gap 704 is defined for the mobile terminal 118 for carrying out interfrequency measurements and/or inter-RAT measurements in a first frequency range which is different from a second frequency range used for data transmission using the eRACH. This means that when a measurement is carried out by the mobile terminal 118 there should be no data transmission on the eRACH from or to the mobile radio terminal 118. For example, the mobile radio terminal includes only one transceiver which, for carrying out the measurements in the first frequency range, is set to the first frequency range and can therefore not be used for sending or receiving data using the second frequency range.

This may apply, depending on the type of measurement, to downlink data transmission and/or uplink data transmission. For the eRACH, time transmission intervals (TTIs) of length 10 ms are defined, of which a first TTI 705, a second TTI 706, a third TTI 707 and a part of a fourth TTI 708 are shown. Note that the beginning of a TTI in this example is not also the beginning of a radio frame. This may be the case because, as explained above, the beginnings of the radio frames 701, 702, 703 are based on the downlink transmission timing while the beginnings of the TTIs 705, 706, 707 are not based on the downlink transmission timing and are not necessarily known to the base station.

In this example, the second TTI 706 and the third TTI 707 overlap with the measurement gap 704 in the second radio frame 702. As a result, the second TTI 706 and the third TTI 707 are not allowed to be fully used for data transmission using the eRACH.

To reduce the transmission delay of the data transmission using the eRACH the mobile terminal 118 selects a DTX pattern based on the length of the measurement gap 704 and the number of measurements to be performed during a measurement gap 704. In this example, it is assumed that the mobile terminal 118 selects the first DTX pattern 401 which includes a first data transmission period 709 in the first radio frame 401, a second data transmission period 710 in the second radio frame 702 and a third data transmission period 711 in the third radio frame 703. The first DTX pattern is assumed to be selected as the most appropriate one with regard to the measurement gap length and the number of measurements to be performed.

The mobile terminal 118 transmits data until the beginning of the second TTI 706 continuously using the eRACH as indicated by block 712 and then, during the second TTI 706 and the third TTI 707 transmits data in accordance with the first DTX pattern 401, i.e. during the second data transmission period 710 as illustrated by block 713 and during the third data transmission period 711 as illustrated by block 714. In the fourth TTI 708, the mobile terminal 118 continuously transmits data using the eRACH as illustrated by block 715. Note that in this embodiment, the data transmission via the eRACH is not interrupted by the measurement gap and the mobile terminal does not need to start the random access procedure for the eRACH after the measurement gap 704.

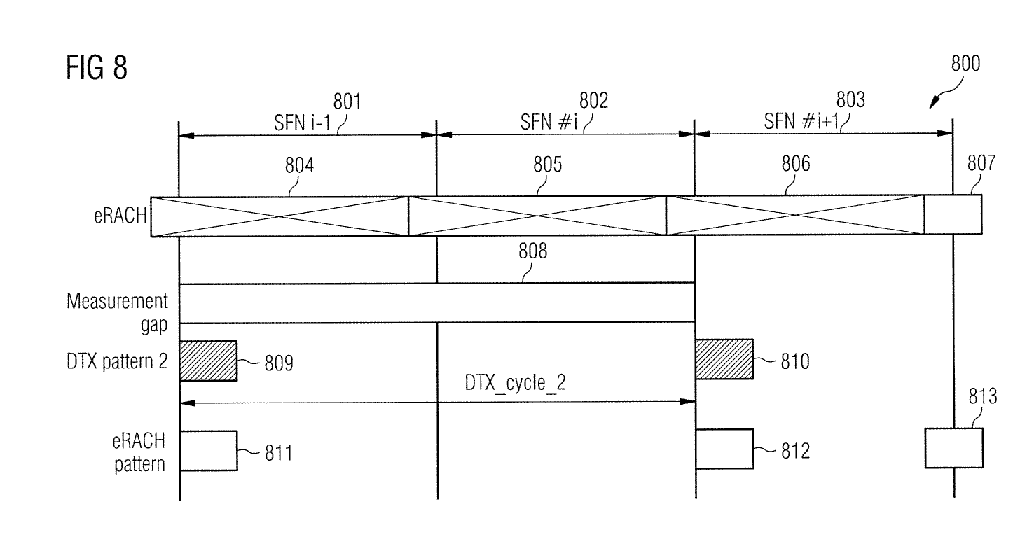

The mobile terminal 118 carries out the measurements during the measurement gap 704 without the second data transmission period 710. The mobile terminal 118 signals the DTX pattern selected, in this case the first DTX pattern 401 and the beginning of the usage of the selected DTX pattern, in this example the beginning of the second data transmission period 710, to the base station, for the example via the DPCCH or the E-DPCCH. The mobile terminal 118 may further signal the end of the usage of the selected DTX pattern, in this example the information that after the third data transmission period 711 the selected DTX pattern is no longer used, to the base station, for example using the DPCCH or the E-DPCCH. Another example is described in the following with reference to FIG. 8.

FIG. 8 shows a flow diagram 800 according to an embodiment.

Analogously to FIG. 7, a first radio frame 801, a second radio frame 802, a third radio frame 803, a first eRACH TTI 804, a second eRACH TTI 805, a third eRACH TTI 806 and a part of a fourth eRACH TTI 807 are shown.

In this example, it is assumed that a measurement gap 808 is defined for the mobile terminal 118 to carry out interfrequency measurements and/or inter-RAT measurements that has a length of 20 ms and occurs periodically every 400 ms.

In this example, the first TTI 804, the second TTI 805 and the third TTI 806 overlap with the measurement gap 808 and are therefore not allowed to be fully used for data transmission. In this example, to reduce the transmission delay on the eRACH caused by the measurement gap, the mobile terminal 118 selects the second DTX pattern 402 as the most appropriate DTX pattern with regard to the length of the measurement gap 808 and the number of measurements to be carried out.

Accordingly, a first data transmission period 809 in the first radio frame 801 and a second data transmission period 810 in the third radio frame 803 are defined. The mobile terminal transmits data according to the selected DTX pattern during the TTIs that are not allowed to be fully used for data transmission. This means that the mobile terminal transmits data using the first data transmission period 809 as indicated by block 811 and using the second data transmission period 810 as indicated by block 812.

After the measurement gap 808 and after the last TTI that is not allowed for full data transmission, in this example the third TTI 806, the mobile terminal 118 continues to use the eRACH for normal data transmission and continues to send data as indicated by block 813. The mobile terminal 118 carries out its measurement during the measurement gap 808 without the first data transmission period 809. As in the examples described with reference to FIG. 7, the mobile terminal 118 may signal the selected DTX pattern, the start of the usage of the selected DTX pattern and the end of the usage of the selected DTX pattern to the base station, for example using the DPCCH or the E-DPCCH.

By allowing discontinous transmission during measurement gaps the transmission delay, in this case the uplink transmission delay on the eRACH, may be significantly reduced. Further, the closed-loop power control for the eRACH can be efficiently maintained.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for transmitting data comprising:
determining at least one allowable time period which is allowed to be used for data transmission via a communication channel during a time interval which is pre-defined as a transmission gap for the communication channel for carrying out measurements in a first frequency range which is different from a second frequency range used for data transmissions via the communication channel; and
transmitting data during the at least one allowable time period via the communication channel.

2. The method according to claim 1, further comprising carrying out the measurements during the time interval.

3. The method according to claim 2, further comprising carrying out the measurements during other time periods of the time interval than the at least one allowable time period.

4. The method according to claim 1, further comprising receiving a specification of the at least one allowable time period.

5. The method according to claim 4, wherein the specification is received from a network component of a communication network.

6. The method according to claim 1, wherein the determining of the at least one allowable time period comprises determining a pre-defined pattern of allowable time periods.

7. The method according to claim 1, wherein the determining of the at least one allowable time period comprises determining a plurality of allowable time periods and selecting the at least one allowable time period from the plurality of allowable time periods based on a pre-determined criterion.

8. The method according to claim 7, wherein the selection is based on the length of the measurement gap.

9. The method according to claim 7, wherein the selection is based on the number of measurements to be performed.

10. The method according to claim 1, further comprising signaling to a network component of a communication network a specification of the at least one determined allowable time period.

11. The method according to claim 1, being carried out by a mobile communication terminal of a mobile communication system.

12. The method according to claim 11, wherein the measurement is a measurement of the reception quality of a signal sent by a base station of the mobile communication system

13. The method according to claim 12, wherein the measurement is a measurement of the reception field strength of a signal sent by the base station in a radio cell.

14. The method according to claim 11, wherein the data transmission is an uplink data transmission from the mobile communication terminal to a base station of the mobile communication system.

15. The method according to claim 11, wherein the mobile communication system is a mobile communication system according to UMTS.

16. The method according to claim 15, wherein the allowable time period is a time period allowed for data transmission via the communication channel when the mobile communication terminal is in CELL_FACH state.

17. The method according to claim 1, wherein the communication channel is a shared communication channel.

18. The method according to claim 15, wherein the communication channel is a random access communication channel.

19. A communication device comprising:
a determining circuit configured to determine at least one allowable time period which is allowed to be used for data transmission via a communication channel during a time interval which is pre-defined as a transmission gap for the communication channel for carrying out measurements in a first frequency range which is different from a second frequency range used for data transmissions via the communication channel; and
a transmitting circuit configured to transmit data during the at least one allowable time period via the communication channel.

20. The communication device according to claim 19, being a wireless communication device.

21. The communication device according to claim 20, being a mobile communication device of a mobile communication system.

22. A method for controlling a data transmission comprising:
generating a message comprising a specification of at least one allowable time period which is allowed to be used for data transmission via a communication channel during a time interval which is pre-defined as a transmission gap for the communication channel for carrying out measurements by a communication terminal in a first frequency range which is different from a second frequency range used for data transmissions via the communication channel; and
transmitting the message to the communication terminal.

23. A network circuit of a communication system comprising:
a message generating circuit configured to generate a message comprising a specification of at least one allowable time period which is allowed to be used for data transmission via a communication channel during a time interval which is pre-defined as a transmission gap for the communication channel for carrying out measurements by a communication terminal in a first frequency range which is different from a second frequency range used for data transmissions via the communication channel; and
a transmitter configured to transmit the message to the communication terminal.

24. The network circuit according to claim 23, being a base station of a mobile communication system.

25. A communication device comprising:
a determining circuit configured to determine at least one allowable time period which is allowed to be used for data transmission via a communication channel during a time interval which is pre-defined as a transmission gap for the communication channel for carrying out measurements in a first frequency range which is different from a second frequency range used for data transmissions via the communication channel;
a transmitting circuit configured to transmit data during the at least one allowable time period via the communication channel; and
a signal circuit configured to signal a specification of the at least one determined allowable time period to a network component of a communication network.
